(19) United States
(12) Patent Application Publication
(10) Pub. No.: US 2011/0191223 A1
(43) Pub. Date: Aug. 4, 2011

(54) Internet Control Management and Accounting in a Utility Computing Environment

(76) Inventors: Alok Singh, Tamil Nadu (IN); Nisheeth Mishra, Tamil Nadu (IN); Sriman Badrinath, Tamil Nadu (IN); Vinodkumar Gopinathan, Tamil Nadu (IN); Venu Gopalraju Kanumuri, Tamil Nadu (IN); Sridhar Kulunthan, Tamil Nadu (IN); Saugata Chakrabarti, Tamil Nadu (IN); Chandra Shekar Kumar, Tamil Nadu (IN)

(21) Appl. No.: 13/056,810

(22) PCT Filed: Jul. 30, 2008
(86) PCT No.: PCT/IN2008/000481

§ 371 Date: Jan. 31, 2011

(51) Int. Cl. G06Q 30/00; G06F 15/173; G06F 7/04

(52) U.S. Cl. 705/34; 709/224; 726/4; 705/30

(57) ABSTRACT

The present invention relates to a method of Internet usage tracking and billing in a utility computing environment and also to a system for control, management and accounting of the said internet usage on per user basis. The present invention is also directed to resolve the issue of same IP address for multiuser and tracking of the Internet usage and bandwidth control on consolidation in utility computing environment, by introducing a separate Utility Computing Internet Control Server (ICS) between the terminal server (TS) and the Internet. All internet traffic originating from the TS are redirected to go through the ICS. The invented system and the method of dynamic control and management according to the present invention deal primarily with the tracking and billing model of the Internet resource in the Utility Computing Environment on per user basis.

### FIELD OF THE INVENTION

The present invention relates to a method of Internet usage tracking and billing in a utility computing environment and also to a system for control, management and accounting said internet usage on per user basis. The users of a utility computing environment access their computing requirements dynamically. Utility computing utilizes a number of components that provide computing to service providers, manage the usage and features requested by users and monitor and manage the different physical components in the environment, such as a thin interface device at the users end, a server farm and the network that connects these two components. The thin interface device is an embedded device or network computer that connects to a server farm to provide the complex applications required by the user. The server consists of two components. One component provides the features and functionality required by the users. The other component manages the complete environment. The computing requirements are not necessarily targeting locally resident user community but are usually accessed across a network. The users use the system resources for the required time and release the same on completion of scheduled task. A user of the utility computing environment accesses the applications and data needs through a session on a server called the terminal server. The utility computing environment would consist of multiple terminal servers based on the number of users in the system. Each terminal server consists of multiple user sessions. This would mean that the Internet session emanating from a single terminal server would have the same IP address and it also adds complexity in tracking the Internet usage for the different users on the same server. The present invention is directed to resolve the issue of same IP address for multiuser and tracking of the Internet usage and bandwidth control on consolidation in utility computing environment, by introducing a separate Utility Computing Internet Control Server (ICS) between the terminal server (TS) and the Internet. This ICS implements the logic required for features like unique IP address, accounting, bandwidth control etc. at a per user level. All internet traffic originating from the TS are redirected to go through the ICS. Thus the resources in this system are shared between a set of users. The invention is thus directed to resource optimization and hence cost optimization, achieved for all the customers and the different players in the Utility Computing Environment. The invented system and the method of dynamic control and management according to the present invention deal primarily with the tracking and billing model of the Internet resource in the Utility Computing Environment on per user basis.

### BACKGROUND ART

The current Internet billing models for home Personal Computers (PC) are based on a model where the Internet connections emanate directly from the PC through the last mile. This implies that each of the users demand dedicated Internet bandwidth from their PC to the Internet. The monitoring of the Internet usage e.g. the data and time are based on the number of bytes sent out and entering the PC to and from the Broadband Remote Access Server (BRAS) belonging to the Internet Service Provider (ISP). So the ISP's BRAS keeps track of duration and quantum of Internet bandwidth and data usage from a PC and this data is used for billing purposes. In the conventional model, the PC is connected through a modem to a remote ISP server that authenticates the user. The ISP BRAS then starts the process that tracks the Internet usage for the user. The user's modem and hence the PC is then returned the configuration details like IP address, DNS address, etc. All the connections are established directly from PCs to the Internet and this remote BRAS tracks the data the flows between the Internet and the PC. The BRAS passes this data to an accounting server through standard accounting protocols like RADIUS/TACACS. A billing server then interacts with the accounting server to collect the details and does the billing process.

The current utility and network computing environments do not track and bill the Internet usage against each user but the tracking is consolidated on the whole. This is because the actual internet application for each user are executed from terminal servers (TS) residing in the server farm. Only a virtual screen display is carried out in the thin client. Due to this, the internet traffic of all users actually originates from the server farm network and then goes towards the internet. For such utility computing environments, ISPs generally give a dedicated virtual circuit connection from the thin clients to the server farm for carrying the display traffic between them. The ISPs usually also give a high bandwidth fat pipe between the server farm and the Internet gateway router to be used for the consolidated Internet traffic of all users. Since only Internet traffic (and not display traffic) uses the internet resources of the ISP, ISPs typically want accounting information at a per user level only for internet traffic. Currently, no such billing mechanism exists to track the Internet traffic usage at a per user level for utility computing environment. Conventionally, in the existing tracking, accounting and billing procedure, there is no consolidation of the Internet bandwidths before the Internet Service Provider's (ISP) gateway. Each of the clients has a unique path from the customer premises right up to the gateway through a BRAS and for assured Quality of Service (QoS) this would require a lengthy and high bandwidth network from the customer premises to the ISP's gateway.

The existing system of tracking, accounting and billing of internet usage by individual user/PC thus suffered from the following disadvantages/limitation:
i) The PC at a customer premise is connected directly to the Internet. Each of the customers is promised and provided with a particular bandwidth. The bandwidth that is currently provided to the customers has already been raised to multiple Megabits per seconds (Mbps) in many of the developing and developed countries. This increase has been driven by the richer content that is streamed through the Internet e.g. Multimedia content. Further, the availability of the additional bandwidth is making the content richer and hence is driving up the Internet bandwidth requirement per PC. Thus all of the bandwidth is getting used up by these content. Thus the demand for higher bandwidth is in a vicious loop. This puts a heavy load on the ISP's network i.e. the part of the network from the customer's premises to the ISP's Gateway. Thus the number of potential choking points for a customer increases and the chance of failure and inability to meet expectations of service standards increases. Consolidating the Internet traffic at a point closest to the Internet Gateway can reduce these issues and the bandwidth from the Gateway to customer premise should be maintained constant.
   This is achieved by the utility computing environment by making Internet access, applications and data reside on a server farm. These are accessed by network computers as per user request.
ii) The current Internet billing mechanism demands unique identification of the equipment/PC at the individual customer premise. The tracking of the Internet usage occurs based on the unique identifiers such as the IP addresses assigned to the customer premise equipments, viz., PC by the ISP. The data that flows from the PC are tagged with these IP addresses and based on these the data exchange is recorded and split among users. Additionally for security purposes, to track spurious cyber attacks, cyber laws in some countries insist that each user's Internet traffic originates from a unique source (non-shared) IP address for back tracking purposes.
   In the existing architectures, if a consolidation, as in the utility computing environment, is brought in then the Internet usage tracking and billing mechanism would bundle multiple customers into a single identifier (IP address of a TS residing in the server farm) and thus the ability to track and bill individual customers is lost.
iii) The conventional system permits the customers to have choice of different upstream/downstream bandwidths and depending on this they are charged differently. This implies that the ISP controls the bandwidth offered to the customer by individually identifying the PC's IP address.
   In the utility computing environment, on consolidation the uniqueness of the customer's device is lost and hence it is not possible to identify the customers separately. This leads to the inability to provide different bandwidths to requesting customers.
iv) For home PC based environments, internet traffic usage is calculated by the ISP's BRAS and accounting information for each consumer is sent to the ISP's accounting server by the BRAS.

However, in the utility computing environments, end PCs will not have a point-to-point session with the BRAS and hence one of the servers in the server farm has to do the accounting for each user and store it locally in a vendor specific proprietary format. But ISPs normally expect accounting data to be sent to their accounting servers using one of the standard protocols like RADIUS/TACACS.

There has been, therefore, a persistent need in the art to develop a method of Internet usage tracking and billing in a utility computing environment and a system for control, management and accounting said internet usage on individual user basis, so as to access the computing requirements dynamically in said utility computing environment. The utility computing environment would provide means wherein Internet access, applications and data reside on a server farm and are accessed by network computers as per users request. Moreover, a consolidation, as in the utility computing environment, would bundle multiple customers Internet usage tracking and billing mechanism into a single identifier (IP address of a TS residing in the server farm) such that ability to track and bill individual customers would not be lost. The utility computing environment, making use of consolidation would also be capable to identify the customer's equipment/PC separately in order to provide different bandwidths on request. Also in the utility computing environment, in absence of a point-to-point session with the BRAS and end PCs, to send data to the ISP's accounting server using one of the standard protocols like RADIUS/TACACS instead of one of the servers in the server farm do the accounting for each user, typically providing accounting information at a per user level and a billing mechanism to track the Internet traffic usage at a per user level for utility computing environment. Thus the present invention is potentially applicable for supporting dynamic accounting information and billing and usage management and control, for internet based applications on wider scale either for ISPs or other service oriented host servers transacting business on internet to a large segment of end users.

### OBJECTS OF THE INVENTION

It is thus the basic object of the present invention to provide a method to track, store, control and manage the Internet usage data in a multiuser utility computing environment and a system for its implementation, so as to access the computing requirements dynamically in said utility computing environment.

Another object of the present invention is directed to a method to dynamically control and manage the Internet usage in a utility computing environment that would allow only authenticated users by advantageous generation and utilization of each user specific unique. IP address to use an ISP's Internet bandwidth after authenticating respective user's identity with the ISP's Authentication server and a system for implementing such a manner of internet usage and control.

A further object of the present invention is directed to a method adapted to track the Internet data exchange done by individual users of the utility computing environment and reports the billing data to the ISP in a standard compliant protocol like RADIUS/TACACS and to a system for implementing such a method.

A still further object of the present invention is directed to a method of control and managing the Internet usage data wherein it controls the upstream/downstream bandwidth available to individual users in a utility computing environment and to a system for carrying out such a method.

A still further object of the present invention is directed to a method and system adapted to take the per-user internet upstream/downstream byte usage data from the local accounting database and forward periodic accounting messages at a per-user level to the ISP's accounting server thereby favoring maintaining user specific internet usage accounting and billing.

### SUMMARY OF THE INVENTION

Thus according to the basic aspect of the present invention there is provided a method for internet control and management in a utility computing environment comprising:
identifying each user in a utility computing environment by a unique IP address at any given point of time;
authenticating each user in a network of computers having said unique IP address and connected to a terminal server with the ISP's authentication server such that only authenticated internet access requests are forwarded to the ISP's gateway;
allowing only authenticated users to use said ISP's Internet bandwidth for accessing internet; and
tracking the internet data exchange done by the individual users based on said unique IP address in a utility computing environment.

Another aspect of the present invention directed to said method for internet control, management and accounting internet usage in a utility computing environment comprising:
identifying each user in a utility computing environment by a unique IP address at any given point of time;
authenticating each user in a network of computers having said unique IP address and connected to a terminal server with the ISP's authentication server such that only authenticated internet access requests are forwarded to the ISP's gateway;
tracking the internet data exchange done by the individual users based on said unique IP address in an utility computing environment; and
generating billing data of respective users based on the said respective usage and data exchange.

According to a further aspect of the present invention directed to a method for internet control, management and accounting internet usage in a utility computing environment wherein the billing data is reported to the ISP in a standard compliant protocol.

According to another advantageous aspect of said method comprising controlling the upstream/downstream bandwidth available to individual users in the utility computing environment.

A still further aspect of the present invention directed to said method wherein plurality of terminal servers are provided each having networked connection of plurality of users and each of the terminal servers enable running multiple sessions.

According to yet another aspect of the present invention directed to said method for internet control, management and accounting internet usage in an utility computing environment, wherein the requests for internet access and data exchange from users through said terminal server is routed through an utility computing internet control server (ICS) between the terminal server and the internet.

In accordance with a preferred aspect of the invention the above method for internet control, management and accounting internet usage in a utility computing environment includes:

classifying web traffic at a per-user level by forcing every web request emanating from the terminal server to have authentic information of users, authenticating the user with the ISP's authentication server when an user starts a new internet session and also initiating session accounting in the ISP's accounting server when the user starts/ends a session;

assigning a unique public IP address for each user and interacting with the network driver to create separate logical channels for each active user and tagging outgoing web requests with the public IP address allotted to the user originating the web request and effecting upstream/downstream bandwidth control at a per-user level of web traffic and periodically storing per user upstream/downstream byte usage in a local accounting database.

According to a still further aspect of the present invention the same is directed to a method for internet control, management and accounting internet usage in a utility computing environment wherein said step of having authentication information of user comprises obtaining user name/password pair, constructing standard authentication protocol and forwarding to the ISP's authentication server, receiving the reply and ascertaining the success/failure of authentication.

A still further aspect of the present invention is directed to said method wherein said step of implementing the user specific web usage accounting comprises receiving session connect/disconnect information, constructing standard accounting protocol complaint sessions start/stop messages and forwarding to the ISP's accounting server including obtaining the internet upstream/downstream byte usage data from the local accounting database and sending periodic accounting messages at a per-user level to the ISP's accounting server.

Further the present method for internet control, management and accounting internet usage in an utility computing environment includes steps wherein on receipt of every fresh web request checking whether the user's password in the web request matches the password successfully authenticated by the ISP authentication server for that user maintained in the local cache of successful users, maintained for a pre-selected time only, so as to continuously update and remove stale cached entries including passwords and corresponding unique public IP address and (i) if so, assign a unique public IP address to the user and allowing the user for web access and (ii) if the password does not match with a previously authenticated password then the web request with password is forwarded to the ISP's authentication server and if it is allowed the password is stored in the local cache and assigned a unique IP address for authorized web access, if not, the web request is dropped.

According to a further aspect of said method comprising performing Source Network Address Translation (SNAT) including changing the source address of the web request to a unique public IP address by rewriting the source IP address field of all the web request packets of the user with unique public IP address allotted to the user on web requests packets going out of the Internet Control Server (ICS) and reverse translation performed by the ICS to the web reply packets coming from the internet before forwarding them to the terminal server.

A still further aspect of the present invention is directed to said method for internet control, management and accounting internet usage in an utility computing environment wherein the source code of the packets form different web requests would be different enabling the terminal server to distinguish web replies based on web reply packet destination port.

An yet further aspect of the present invention is directed to said method for controlling internet usage in an utility computing environment wherein the upstream/downstream bandwidth available to a user's internet traffic is being based on the package chosen by the user with the ISP.

Another important aspect of the present invention is that the web traffic of each user goes out/enters in through a distinct logical interface, the OS's interface statistics is used to track the internet usage of each user with counters reset to zero every time when a logical interface is created said counters used to store the byte usage for upstream/downstream internet traffic if each user in the accounting server database, the accounting server periodically querying this database and sending standard complaint per user accounting message to the ISPs accounting server and at the end of the user's internet session, the ICS frees up the IP address assigned to the user and informs the ISP's accounting server of the end of the session with all information on the amount of data exchanged being passed to the above mentioned accounting server.

A further aspect of the present invention is directed to a system for carrying out the method for internet control and management in an utility computing environment comprising:
at least one terminal server operatively connected to plurality of network computers, said terminal server adapted to run sessions corresponding to each user run;
an utility computing internet control server providing for individualized user specific sessions based access to the internet through ISP gateway and adapted such that (i) each user in a utility computing environment is identified by a unique IP address at any given point of time; (ii) each user in the utility computing environment with the above mentioned unique public IP address is authenticated against the ISP's authentication server through the terminal server so that only authenticated internet requests are forwarded to the ISP's gateway; (iii) allowing only authenticated users to use said ISP's Internet bandwidth for accessing internet ;and (iv) tracking the internet data exchange done by the individual users based on said unique IP address in an utility computing environment.

Further said system for carrying out the method for internet control and management in a utility computing environment comprising:
at least one terminal server operatively connected to plurality of network computers, said terminal server adapted to run sessions corresponding to each user run;
an utility computing internet control server providing for individualized user specific sessions based access to the internet through ISP gateway and adapted such that (i) each user in a utility computing environment is identified by a unique IP address at any given point of time; (ii) each user in the utility computing environment with the above mentioned unique public IP address is authenticated against the ISP's authentication server through the terminal server so that only authenticated internet requests are forwarded to the ISP's gateway; (iii) allowing only authenticated users to use said ISP's Internet bandwidth for accessing internet; (iv) tracking the internet data exchange done by the individual users based on said unique IP address in an utility computing environment and (v) generating billing details of each network user specific internet usage.

According to a further aspect of the present invention the said utility computing internet control server comprises an internet control server operatively connected to said terminal servers, ISP gateway for said authorized user specific internet access and ISP AAA Servers for authenticating each network user requesting web access based on an unique IP address and maintaining user specific and session specific accounting details and said ISP AAA Servers are adapted to generate user specific billings and said internet usage of respective users are stored in an internet usage storage based on usage information generated by said internet control server for generation of customer internet usage report. A still further aspect of the system according to the present invention is that the said internet control server comprises:
a Connection Daemon adapted for (i) each user authentication and generation of a unique IP address and operatively connected to a network control module to generate an unique IP address and to the ISP AAA Servers through an authentication module and (ii) start and end accounting of web usage of respective user based on the assigned and authenticated IP address by its operative connection to said ISP AAA Servers through an accounting module; and
said Network Control Module adapted to connect to the internet based on authenticated unique IP address based web requests through network driver and ISP gateway and support an user specific Internet Usage Storage adapted to favor logging user information with IP address and time.

According to yet another aspect of the system the said network control module is adapted to process each web request from a particular user received from the terminal server and the source network address translation (SNAT) is applied therein to the request packet and sent out of a logical interface allotted to the particular user, the web reply is also entered into the internet control server through said same logical channel allotted to the specific user.

said system of the present invention wherein said internet control server is adapted to transfer back the public IP address allotted to the user to the IP address pool maintained by the network control module with the said network module adapted for updating the accounting server database with the final usage data of the user and removing the logical interface of the user along with a disconnect message to the accounting module whereby the accounting module is adapted to forward an accounting disconnect along with summary of usage byte for the specific user to the ISPs accounting server.

Further said system according to the present invention wherein the external interface of the internet control server facing the IPS's internet gateway comprises multiple public IP addresses such that the reply packets are routed to and within the internet control server, said external interface being partitioned into multiple logical channels, each having a unique public IP address allotted to different users whereby the network control module in operative connection with network OS/driver running in the internet control server is adapted to create new logical channel for each user at the time of connection/session establishment of the user, said logical channel being adapted for sending out web request packets of the user and also for receiving back corresponding web reply, said logical channel being removed once the user session ends/disconnects.

Another aspect of the present invention is directed to said system wherein the upstream/downstream rate limit for the logical channel is set based on the package subscribed by the user belonging to the logical channel whereby the internet control server ensures that each user gets the ISP allotted bandwidth in both upstream/downstream directions for internet usage.

A still further aspect of the present invention directed to said system wherein said network control server is adapted such that the web traffic of each user goes out/enters in through a distinct logical interface and the OS interface statistics is adapted to track the internet usage of each user wherein counters are reset to zero when a logical interface is created which are used to store the byte usage for upstream/downstream internet traffic of each user in the accounting database server, accounting server adapted to periodically query this database and send standard compliant per-user accounting messages to the ISP's accounting server, said Internet control server adapted to free up the IP address assigned to the user at the end of the user's internet session and informs the ISP's accounting server of the end of the session.

The present invention and its objectives and advantages are described in greater details with reference to the following non-limiting accompanying illustrative figures.

### BRIEF DESCRIPTION OF THE ACCOMPANYING FIGURES

FIG. 1: is the illustration of the existing Internet deployment architecture.

FIG. 2: is the illustration of various Components for Internet Billing in the Utility Computing environment, according to the present invention.

FIG. 3: is the illustration of the detailed framework for Volume based Internet Billing of the present invention.

FIG. 4: is the illustration of components and message flow in an embodiment of the invention when user connects to Internet.

FIG. 5: is the illustration of components and message flow in an embodiment of the invention during usage of Internet.

FIG. 6: is the illustration of components and message flow in an embodiment of the invention when user disconnects from Internet.

### DETAILED DESCRIPTION OF THE ACCOMPANYING FIGURES

As already described, the basic principle of the utility computing environment is the consolidation of resources. Internet being an important resource in any computing environment is also consolidated in the utility computing environment. The current invention deals with the tracking and usage management model of Internet in this consolidated environment. Since consolidation does not happen in the existing PC based environment the current Internet model demands the existence of Independent Internet connections from the customer premises itself. The present invention describes a framework and mechanisms to control and manage the Internet usage in a utility computing environment.

This utility computing environment comprises of network computers which are clients that connect to a server, called the terminal server (TS), across a network. The network computers do not contain all the applications and data required by the user. These are present in a server of which the above mentioned TS form an integral part. When a user desires to use an application or data, the network computer connects to the terminal server, where a user session is run. Through this session the user can access the required application or data. Each of the TS can run multiple sessions. The number of sessions that can be run on a terminal server depends of the capability of the server defined by processing power and memory available, and the operating system used on the server (Microsoft Windows, Linux, etc.).

User access to the Internet also happens from the above mentioned terminal servers. The Internet access happens from applications like browsers and chats. Multiple users can connect to the Internet at the same time by running the mentioned Internet applications on single TS. This implies that the Internet data corresponding to different users emanate from the same server i.e. the IP address, corresponding to the TS, is sent out to the Internet even though there are different users. The current Internet control, management and billing mechanism used by ISPs work on the principle of unique IP address for each user i.e. each user of the Internet sends a unique IP address as a part of their request. But in the case of utility computing, multiple user requests contain the same IP address and hence differentiation cannot be done.

The current invention resolves this issue by introducing a separate Utility Computing Internet Control Server (ICS) between the terminal server and the Internet. This ICS implements the logic required for features like unique IP address, accounting, bandwidth control etc. at a per user level. All internet traffic originating from the TS are redirected to go through the ICS. This redirection can be achieved in multiple ways using techniques like
a) Configuring internet applications like browser to use a proxy and assigning the ICS's IP address as the proxy;
Or,
b) change the default route on the internet facing interface of the TS from the ISP's gateway router to that of ICS.

The TS is configured such that it cannot interact directly with the ISP's Gateway and the user is not given the right to change this setting.

The manner of implementing the method of per user based tracking managing and control under utility computing environment using the system of the present invention is achieved through the functionality of ICS that comprised four main logically split components:

A. Connection Daemon; B. Network Control Module; C. Authentication Module and D. Accounting Module.

A high level overview of the respective functionalities of these components are as follows:

Connection Daemon (CD)—Helps in classifying web traffic at a per-user level by forcing every web request emanating from the TS to have authentication information of users. It interacts with the “Authentication Module” for authenticating the user with the ISP's authentication server, when a user starts a new internet session. It also interacts with the “Accounting Module” for initiating session accounting START/STOP messages to be sent to the ISP's accounting server, when a user starts/ends a session.

Network Control Module (NCM)—Takes classified per-user web requests from CD, assigns a unique public IP address for each user, interacts with the network driver of ICS to create separate logical channels for each active user, tags outgoing web requests with the public IP address allotted to the user originating the web request and enforces upstream/downstream bandwidth control at a per-user level for web traffic. It also periodically stores per user upstream/downstream byte usage in a local accounting database.

Authentication Module—Implements the client functionality of standard authentication protocols like RADIUS/TACACS. On initiation from CD, this module takes the username/password pair from CD, constructs standard authentication protocols compliant messages, sends it to the ISP's authentication server, receives the reply from the ISP's authentication server and reports authentication success/failure result to CD.

Accounting Module—Implements the client functionality of standard accounting protocols like RADIUS/TACACS. On initiation from CD, this module takes session connect/disconnect messages from CD, constructs standard accounting protocol compliant session START/STOP messages, sends it to the ISP's accounting server. It also takes the per-user internet upstream/downstream byte usage data from the local accounting database and sends periodic accounting messages at a per-user level to the ISP's accounting server.

Since the roles of the “Authentication” and “Accounting” modules are simple and self-explanatory, detailed explanation is provided below only for CD and NCM.

Detailed description of CD's functionality is as follows:

Per user traffic Classification: For the web requests, originating from the internet applications running on the TS, to mandatorily contain authentication information (username/password). Since all web requests originating from the TS are redirected through the ICS, logic is introduced in CD to check for the presence of authentication information in the web requests originating from the TS. Usually all web protocols, e.g. Hypertext Transfer Protocol (HTTP) or Session Initiation protocol (SIP), have provision for sending authentication information as a separate parameter as part of the protocol header fields. So logic is implemented in CD to monitor each web request originating from the TS for the presence of the authentication parameter. If this parameter is absent in a web request packet originating from the TS, CD does not forward the request onto the ISP's gateway (it drops the request) and sends a reply back to the web application running in the TS indicating that the web requests sent by it MUST have authentication information. This way the web applications running in the TS are forced to send per-user authentication information as part of the web requests sent out. By looking at the authentication information of each web request, CD can classify the actual end-user originating the request.

Authentication with ISP's authentication server: When a user first attempts to use internet, the user's authentication credentials would have to be authenticated by an ISP authentication server. Only after this should the user's requests be allowed to go on to the internet. This is accomplished by the CD maintaining a local cache of already successfully ISP authenticated users. When CD gets a web request, it checks this cache to see if the user originating the request has already been authenticated by the ISP's authentication server. If true, then it checks whether the user's password in the web request matches the password successfully authenticated by the ISP authentication server for that user (the username/password is stored in the cache once ISP authentication server successfully authenticates a user). If the password check matches, then the web request is forwarded by CD to the “Network Control Module (NCM)” of ICS. If the user's entry is not present in the local cache, then CD assumes that the user has started a new session of internet activity and hence tries to authenticate the user with the ISP's authentication server by interacting with the local “Authentication Module”. If authentication is successful, CD adds this authentication information onto its cache. The web request is forwarded onto NCM. If the ISP's authentication server returns a failure, then the web request is dropped at CD itself and an appropriate message is sent to the TS application. A session-timeout is also maintained to remove out stale cached entries.

Per User unique public IP address assignment: As soon as a user attempting to access internet is successfully authenticated by the ISP's authentication server, the CD assigns a unique public IP address to this user. This public IP address can either be got from NCM (a locally stored pool of public IP addresses allotted by the ISP) or from the authentication reply sent by the ISP's authentication server.

Accounting session START/STOP messages: CD sends connect/disconnect messages to the Accounting daemon running on the ICS whenever a user starts/ends a session. The Accounting daemon then sends ISP accounting protocol specific accounting START/STOP messages to the ISP's accounting server.

Detailed description of NCM's functionality is as follows:

Changing source address of web requests: At the time of session establishment, each user is assigned a public IP address. The NCM stores this user name to pubic IP address mapping in a local table. When the NCM receives web requests from CD, it reads the user name from the authentication parameter present in the web request, it then finds out the corresponding public IP address from its local table. This public IP address will be used by the NCM when the user's Internet traffic is sent out. This is accomplished by rewriting the source IP address field of all the web request packets of this user with the unique public IP address allotted to this user. This process is called basic Source Network Address Translation (SNAT). As SNAT is performed on web request packets going out of ICS, correspondingly, reverse'translation would have to be performed by the ICS, to the web reply packets coming from the internet before forwarding them to the TS, as the TS is not aware of the NAT operations being done in ICS. Note that since all web requests are emanating from the TS, though the source IP address of the web request packet coming from the TS is the same for all users, the packet's source port would be able to distinguish web replies coming for multiple users. Hence, there is no problem for doing reverse translation as the NCM just has to replace the destination IP address of the web reply packet with the IP address of the TS. The TS would still be able to distinguish web replies based on the web reply packet's destination port (this is nothing but the source port in the corresponding web request packet and hence is different for each user). Thus using CD and NCM, per-user traffic is classified and sent out with a unique public IP address when sent on to the internet. This is a requirement from almost all ISPs due to cyber laws.

Creating per user logical channels: Due to the SNAT operation being done at the ICS, packets sent out of the ICS onto the ISP's gateway would have a unique source IP address for each user. This means that the corresponding web reply packets coming into the ICS from the internet would be having a destination IP address equal to that of the public IP address allotted to the user to whom this web reply is intended for. This means that the external interface of the ICS facing the ISP's internet gateway has to have multiple public IP addresses, so that reply packets are routed to and within ICS. To achieve this, the external interface is partitioned into multiple logical channels, each having a unique public IP address (allotted to different users). Almost all networking OS support this feature. Hence, the NCM, with the help of the network OS/driver running in the ICS, creates a new logical channel for each user at the time of connection/session establishment of the user. This logical channel would be used for sending out web request packets of the user and also for receiving back the corresponding web reply. The logical channel would be removed once the user session ends (disconnects).

Controlling per user upstream/downstream bandwidth: The upstream/downstream bandwidth available to a user's internet traffic should be based on the package chosen by the user with the ISP. Typically all networking OSs support QOS techniques that enable one to control the upstream/downstream rate of traffic leaving/entering an interface. For upstream rate limiting, standard techniques, like, Leaky bucket, Token Buffering, class-based weighted fair queuing etc. can be used. For downstream rate limiting, standard techniques like policing, dropping based on Random Early Detection (RED), Weighted Random early detection (WRED) etc. can be used. Since the NCM has ensured that the web traffic of each user goes out/enters in through a distinct logical interface, any of these standard QOS features can be applied on the logical interfaces to achieve per-user bandwidth control. The upstream/downstream rate limit for a logical channel is set based on the package subscribed by the user belonging to the logical channel. Thus ICS ensures that each user only gets the ISP allotted bandwidth in both upstream/downstream directions for internet usage.

Calculating per user upstream/downstream byte usage: Typically, all networking OSs support statistics in the form of sent/received bytes counters on physical as well as logical interfaces. Since the NCM has ensured that the web traffic of each user goes out/enters in through a distinct logical interface, the OS's interface statistics can be used to track the internet usage of each user. These counters are reset to zero when a logical interface is created. The NCM uses these counters to store the byte usage for upstream/downstream internet traffic of each user in the accounting database server. The Accounting server periodically queries this database and sends standard compliant per-user accounting messages to the ISP's accounting server. Thus the ICS tracks the traffic that is generated by each user and updates the ISP's accounting server directly at regular intervals. At the end of user's Internet session, the ICS frees up the IP address assigned to the user and informs the ISP's accounting server of the end of session. All information on the amount of data exchanged is passed to the above mentioned accounting server. The passing of amount of Internet data exchange at regular intervals ensures that the data exchange can be tracked accurately even if any part of the system breaks down.

Thus the present framework and architecture resolves all the problems of prior art mentioned in the previous paragraphs.

Reference is first invited to accompanying FIG. 1 that illustrates the architecture that is used in the existing deployments for Internet billing is described. The current deployments are based on having a PC at the user end. This would mean that the PC runs all the Internet related applications, like browser locally and the PC is connected to the Internet network. The PC would require the assured bandwidth right through the ISP's network to the Internet. The PC interacts to the ISP through the ADSL modem using the Point to Point Protocol (PPP). The PPP protocol happens between the ADSL modem that is connected to the PC and the Broadband Remote Access Server (BRAS). The BRAS authenticates the user and keeps track of the Internet usage of the user. Based on the authentication information sent to the BRAS a unique IP address is assigned to the modem (and hence the PC). The data coming from/going to the PC is kept track by the BRAS, using the above mentioned IP address, to estimate the Internet usage. The Internet usage information is passed on to the ISP's Accounting server.

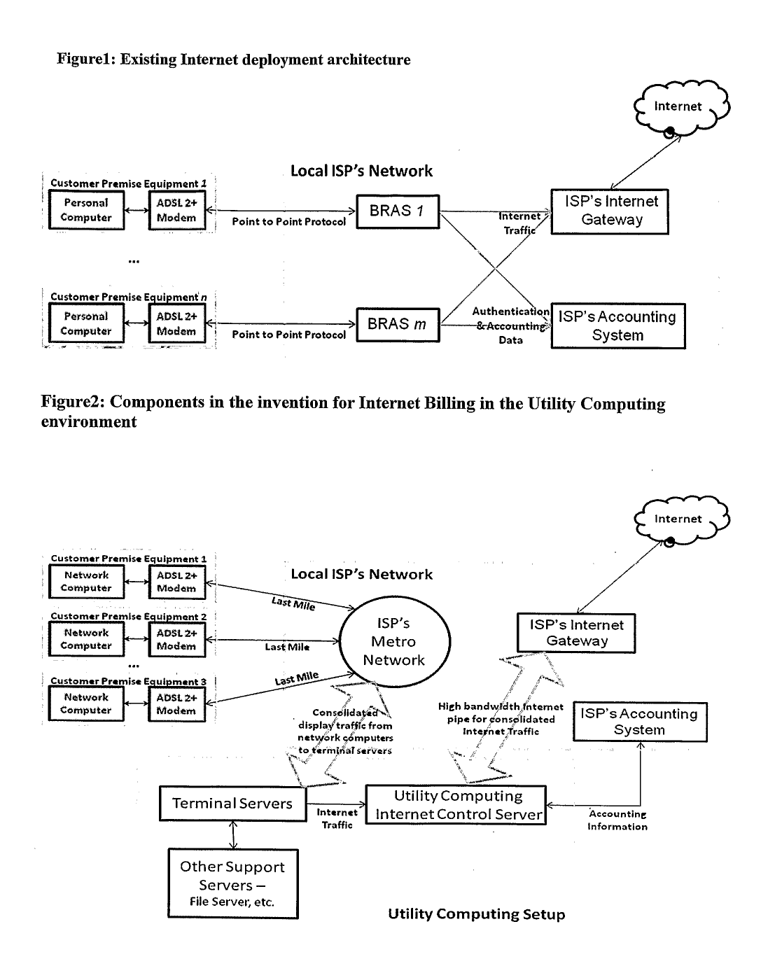

Reference is next invited to the accompanying FIG. 2 that illustrates schematically the overview of the architecture of the present invention having a new component named Internet Control Server (ICS). The users of the utility computing environment use network computers to access their applications and data. The network computer connects to a Terminal server where sessions corresponding to each user run. The terminal server could run on any of the popular OS like Linux or Microsoft Windows. All the user applications are executed in the terminal server (TS) within the user session. The visual rendering of the applications and the user desktop is communicated to the network computer. Thus the user can interact with his/her applications from remote locations. A typical deployment of a utility computing setup consists of multiple terminal servers. These terminal servers are load balanced so that a new user lands in the terminal server that is least loaded with respect to processing, memory and network usage. Each terminal server contains multiple sessions (i.e.) a number of users are logged onto a single terminal server. The number of sessions that a single terminal server can contain would depend on the processing and memory capability of a server. To access the Internet, the user executes the browser or chat applications on the terminal server. These applications exchange data across the Internet as desired by the user. So each terminal server has multiple connections emanating to the Internet. The goal of this invention is to distinctly identify and control each of these Internet connections and to keep track of the Internet usage of each of these sessions through the usage of the ICS. This enables the effective billing of Internet connection and usage for each user of the utility computing environment. As already described, the network computer and the terminal servers with the supporting file and authentication servers form an integral part of the utility computing environment.

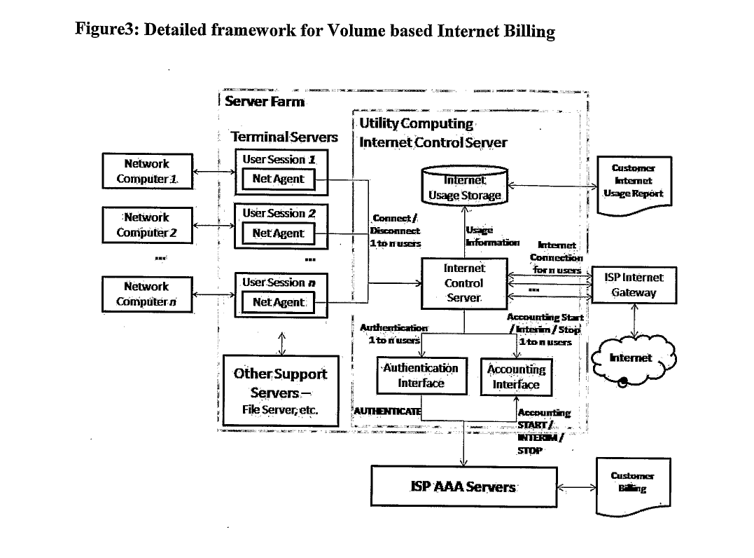

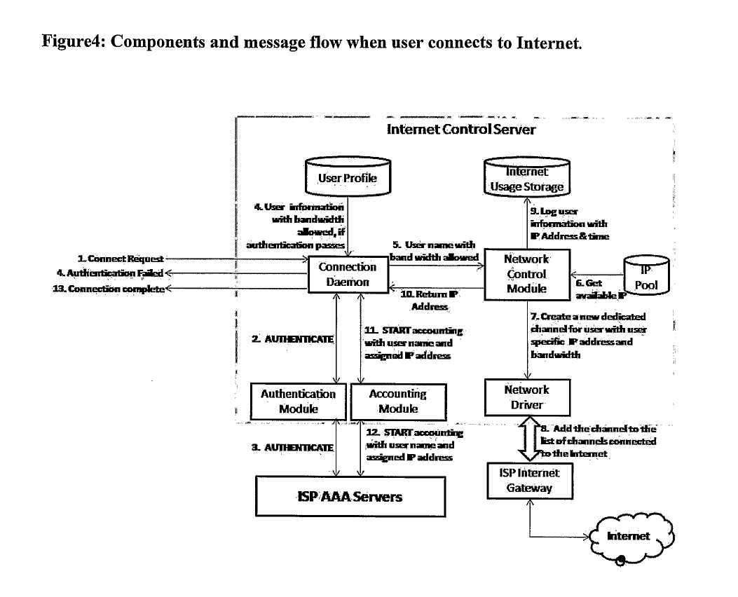

Reference is now invited to FIG. 3 that shows a more detailed view of the sub-blocks of Internet Control Server (ICS) like CD, NCM etc. that are utilized to achieve the mentioned goal. The functionality of each of the components in the FIG. 3 is mentioned in the preceding paragraphs.

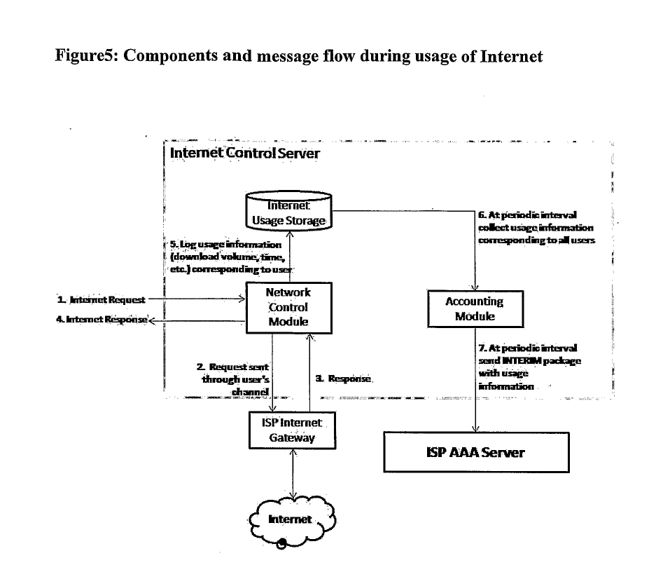

Reference is now invited to accompanying FIG. 4 which shows the control flow when a user starts a new session. As mentioned earlier, when a user starts a new session, the CD module first authenticates the user with the ISP's authentication server before allowing the user's web requests to go out. After successful authentication, a unique public IP address is assigned to the user to be used for sending out all web traffic corresponding to this user. The NCM at this point creates a virtual/logical interface to be used for sending out/receiving in web traffic of this user. A session accounting START message is also sent to the ISP's accounting server using the “Accounting Module” of ICS.

Reference is next invited to the accompanying FIG. 5 shows the control flow during actual internet usage. Each web request of a particular user received from the TS is processed by the NCM. SNAT is applied by NCM to the request packet and it is sent out of the logical interface allotted to the user. Web replies enter the ICS through the same logical channel.

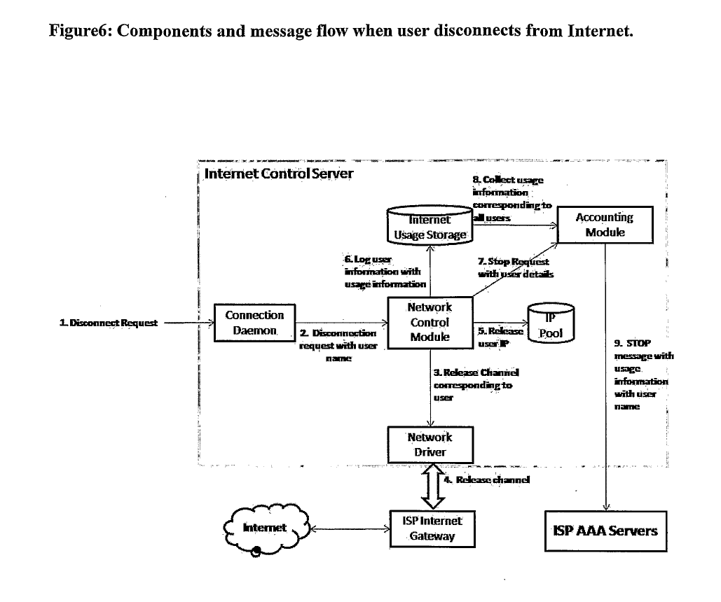

Reference is now invited to the accompanying FIG. 6 which illustrates the control flow when a user ends his session. On receiving a disconnect message from the TS for a user, the ICS gives back the public IP address allotted to the user to the IP address pool maintained by NCM. NCM updates the accounting server database with the final usage data of the user. NCM removes the logical interface created for that user. NCM/ICS sends a disconnect message to the “Accounting Module”, so that the accounting module can send an accounting disconnect (with summary byte usage) message for this user to the ISP's accounting server.

The present invention as illustrated above is thus directed to resolve the issue of assigning user specific unique IP address by a process called basic Source Network Address Translation (SNAT), by introducing a separate Utility Computing Internet Control Server (ICS) between the terminal server and the Internet. This ICS implements the logic required for features like unique IP address, accounting, bandwidth control etc. at per user level basis. The Network Control Module (NCM), with the help of the network OS/driver running in the ICS, creates a new logical channel for each user at the time of connection/session establishment of the user. All internet traffic originating from the Terminal Server (TS) to which a number of user systems/network computers or clients are connected, are redirected to go through the ICS. Thus the ICS tracks the traffic that is generated by each user and updates the ISP's accounting server directly at regular intervals. At the end of user's Internet session, the ICS frees up the IP address assigned to the user and informs the ISP's accounting server of the end of session. The ICS also ensures that each user only gets the ISP allotted bandwidth in both upstream/downstream directions for internet usage. The web traffic of each user goes out/enters in through a distinct logical interface, any of the standard QOS features can be applied on the logical interfaces to achieve per-user bandwidth control. The upstream/downstream rate limit for a logical channel is set based on the package subscribed by the user belonging to the logical channel. Thus ICS ensures that each user only gets the ISP allotted bandwidth in both upstream/downstream directions for internet usage. The ICS tracks the traffic that is generated by each user and updates the ISP's accounting server directly at regular intervals. At the end of user's Internet session, the ICS frees up the IP address assigned to the user and informs the ISP's accounting server of the end of session. All information on the amount of data exchanged is passed to the above mentioned accounting server, enabling the ISPs to bill the internet usage per user basis. The system of the invention is thus providing an effective means for computing and billing the internet usage on per user level dynamically and also manage and control the volume transaction of net traffic and thereby allowing a new entrant to the system when a fresh access request is entered to an evenly loaded Terminal Server with unique IP address assigned on authentication based on interaction with and receiving confirmation from the ISPs. The system of the invention using CD and NCM, per-user traffic is classified and sent out with a unique public IP address when sent on to the internet and thus facilitating complying with the requirement of enforcing cyber laws to almost all ISPs.

It is thus possible by way of the present invention to provide method for authenticating, tracking, controlling and managing the internet usage accounts information and billing on per user basis on utility computing environment and a system for implementing said user specific internet usage accounting and billing. Importantly, the invention is potentially adapted for supporting dynamic accounting information and billing and usage management and control, for internet based applications on wider scale either for ISPs or other service oriented host servers transacting business on internet to a large segment of networked end users.

We claim:

1. A method for internet control and management in an utility computing environment comprising:
a set of client end devices that connect to a set of servers for their applications and Internet needs of its users;
a set of servers each of which provide access to Internet and applications to the set of client devices;
a control server that is capable of identifying each client and hence each user separately through many connections reach the Internet through a common server, called terminal server;
a system that is capable of identifying each user in a utility computing environment by a unique IP address at any given point of time and from anywhere in the Internet though the users connect to the Internet through a common server;
authenticating each user in a utility computing network having the said unique IP address and connected to a terminal server with the ISP's authentication server such that only authenticated internet access requests are forwarded to the ISP's gateway;
allowing only authenticated users of the utility computing network to use said ISP's Internet bandwidth for accessing internet; and
tracking the internet data exchange done by the individual users of the utility computing network based on said unique IP address in an utility computing environment.

2. A method for internet control, management and accounting internet usage in an utility computing environment comprising:
two different networks with different IP address ranges—one between the user end computing access device and the set of utility computing servers and two between the utility computing servers and the Internet;
identifying each user in a utility computing environment by a unique IP address at any given point of time and from anywhere in the Internet;
authenticating each user in a network of computers having said unique IP address and connected to a terminal server with the ISP's authentication server such that only authenticated internet access requests are forwarded to the ISP's gateway;
tracking the internet data exchange done by the individual users based on said unique IP address in an utility computing environment; and
generating billing data of respective users based on the said respective usage and data exchange, wherein the billing data for the users of the utility computing environment are reported to the ISP in a standard compliant protocol.

3. (canceled)

4. The method according to claim 2 comprising controlling the upstream/downstream bandwidth available to individual users in the utility computing environment.

5. The method according to claim 2, wherein plurality of terminal servers are provided each having networked connection of plurality of users and each of the terminal servers enable running multiple sessions such that each user in the terminal server can be identified by a unique IP address from anywhere in the Internet.

6. The method according to claim 4, wherein the requests for internet access and data exchange from users through said terminal server is routed through a utility computing internet control server (ICS) between the terminal server and the internet.

7. The method according to claim 6 comprising:
classifying web traffic at a per-user level by forcing every web request emanating from the terminal server to have authentic information of users, authenticating the user with the ISP's authentication server (AAA Server) when an user starts a new internet session and also initiating session accounting in the ISP's accounting server (AAA Server) when the user starts/ends a session;
assigning a unique public IP address for each user and interacting with the network driver to create separate logical channels for each active user and tagging outgoing web requests with the public IP address allotted to the user originating the web request and effecting upstream/downstream bandwidth control at a per-user level of web traffic and periodically storing per user upstream/downstream byte usage in a local accounting database, wherein said step of having authentication information of user comprises obtaining user name/password pair, constructing standard authentication protocol and forwarding to the ISP's authentication server (AAA Server), receiving the reply and ascertaining the success/failure of authentication, and
wherein said step of implementing the user specific web usage accounting comprises receiving session connect/disconnect information, constructing standard accounting protocol complaint sessions start/stop messages and forwarding to the ISP's accounting server including obtaining the internet upstream/downstream byte usage data from the local accounting database and sending periodic accounting messages at a per-user level to the ISP's accounting server (AAA Server).

8. (canceled)

9. (canceled)

10. The method according to claim 9 comprising on receipt of every fresh web request checking whether the user's password in the web request matches the password successfully authenticated by the ISP authentication server for that user maintained in the local cache of successful users, maintained for a pre-selected time only, so as to continuously update and remove stale catch entries including passwords and corresponding unique public IP address and (i) if so, assign a unique public IP address to the user and allowing the user for web access and (ii) if the password does not match with a previously authenticated password then the web request with password is forwarded to the ISP's authentication server and if it is allowed the password is stored in the local cache and assigned a unique IP address for authorized web access, if not, the web request is dropped.

11. The method according to claim 10 comprising performing Source Network Address Translation (SNAT) including changing the source address of the web request to a unique public IP address by rewriting the source IP address field of all the web request packets of the user with unique public IP address allotted to the user on web requests packets going out of the Internet Control Server (ICS) and reverse translation performed by the ICS to the web reply packets coming from the internet before forwarding them to the terminal server.

12. The method according to claim 11 wherein the source code of the packets form different web requests would be different enabling the terminal server to distinguish web replies based on web reply packet destination port.

13. The method according to claim 12, wherein the upstream/downstream bandwidth available to a user's internet traffic is based on the package chosen by the user with the ISP.

14. The method according to claim 13, wherein the web traffic of each user goes out/enters in through a distinct logical interface, the OS's interface statistics is used to track the internet usage of each user with counters reset to zero every time when a logical interface is created said counters used to store the byte usage for upstream/downstream internet traffic if each user in the accounting server database, the accounting server periodically querying this database and sending standard complaint per user accounting message to the ISPs accounting server and at the end of the user's internet session, the ICS frees up the IP address assigned to the user and informs the ISP's accounting server of the end of the session with all information on the amount of data exchanged being passed to the above mentioned accounting server.

15. The system for carrying out the method for internet control and management in an utility computing environment according to claim 14 comprising:
at least one terminal server operatively connected to plurality of network computers, said terminal server adapted to run sessions corresponding to each user run; and
an utility computing internet control server providing for individualized user specific sessions based access to the internet through ISP gateway and adapted such that (i) each user in a utility computing environment is identified by a unique IP address at any given point of time; (ii) each user in a network of computers is authenticated having said unique IP address and connected to a terminal server with the ISP's authentication server such that only authenticated internet access requests are forwarded to the ISP's gateway; (iii) allowing only authenticated users to use said ISP's Internet bandwidth for accessing internet; and (iv) tracking the internet data exchange done by the individual users based on said unique IP address in an utility computing environment.

16. A system for carrying out the method for internet control and management in an utility computing environment according to claim 14 comprising:
at least one terminal server operatively connected to plurality of network computers, said terminal server adapted to run sessions corresponding to each user run; and
an utility computing internet control server providing for individualized user specific sessions based access to the internet through ISP gateway and adapted such that (i) each user in a utility computing environment is identified by a unique IP address at any given point of time; (ii) each user in a network of computers is authenticated having said unique IP address and connected to a terminal server with the ISP's authentication server such that only authenticated internet access requests are forwarded to the ISP's gateway; (iii) allowing only authenticated users to use said ISP's Internet bandwidth for accessing internet; (iv) tracking the internet data exchange done by the individual users based on said unique IP address in an utility computing environment and (v) generating billing details of each network user specific internet usage.

17. The system according to claim 16, wherein said utility computing internet control server comprises an internet control server operatively connected to said terminal servers, ISP gateway for said authorized user specific internet access and ISP AAA Servers for authenticating each network user requesting web access based on an unique IP address and maintaining user specific and session specific accounting details and said ISP AAA Servers are adapted to generate user specific billings and said internet usage of respective users are stored in an internet usage storage based on usage information generated by said internet control server for generation of customer internet usage report.

18. The system according to claim 17, wherein said internet control server comprises:
a connection daemon adapted for (i) each user authentication and generation of a unique IP address and operatively connected to a network control module to generate an unique IP address and to the ISP AAA Servers through an authentication module and (ii) start and end accounting of web usage of respective user based on the assigned and authenticated IP address by its operative connection to said ISP AAA Servers through an accounting module; and
said network control module adapted to connect to the internet based on authenticated unique IP address based web requests through network driver and ISP gateway and support an user specific Internet Usage Storage adapted to favor logging user information with IP address and time.

19. The system according to claim 18, wherein said network control module is adapted to process each web request from a particular user received from the terminal server and the source network address translation (SNAT) is applied therein to the request packet and sent out of a logical interface allotted to the particular user, the web reply is also entered into the internet control server through said same logical channel allotted to the specific user.

20. The system according to claim 19, wherein said internet control server is adapted to transfer back the public IP address allotted to the user to the IP address pool maintained by the network control module with the said network module adapted for updating the accounting server database with the final usage data of the user and removing the logical interface of the user along with a disconnect message to the accounting module whereby the accounting module is adapted to forward an accounting disconnect along with summary of usage byte for the specific user to the ISPs accounting server.

21. The system according to claim 20, wherein the external interface of the internet control server facing the IPS's internet gateway comprises multiple public IP addresses such that the reply packets are routed to and within the internet control server, said external interface being partitioned into multiple logical channels, each having a unique public IP address allotted to different users whereby the network control module in operative connection with network OS/driver running in the internet control server is adapted to create new logical channel for each user at the time of connection/session establishment of the user, said logical channel being adapted for sending out web request packets of the user and also for receiving back corresponding web reply, said logical channel being removed once the user session ends/disconnects.

22. The system according to claim 21, wherein the upstream/downstream rate limit for the logical channel is set based on the package subscribed by the user belonging to the logical channel whereby the internet control server ensures that each user gets the ISP allotted bandwidth in both upstream/downstream directions for internet usage.

23. The system according to claim 22, wherein said network control server is adapted such that the web traffic of each user goes out/enters in through a distinct logical interface and the OS interface statistics is adapted to track the internet usage of each user wherein counters are reset to zero when a logical interface is created which are used to store the byte usage for upstream/downstream internet traffic of each user in the accounting database server, accounting server adapted to periodically query this database and send standard compliant per-user accounting messages to the ISP's accounting server, said Internet control server adapted to free up the IP address assigned to the user at the end of the user's internet session and informs the ISP's accounting server of the end of the session.
